(19) United States
(12) Patent Application Publication
(10) Pub. No.: US 2010/0141072 A1
(43) Pub. Date: Jun. 10, 2010

(54) Composite Rotor Of A Step Motor And Method For Producing The Same

(76) Inventors: CHIA-CHUN WEI, Taichung (TW); Chia-Ming Chang, Taichung (TW)

Correspondence Address: Dr. BANGER SHIA;Patent Office of Bang Shia, 102 Lindencrest Ct., Sugar Land, TX, 77479-5201, US

(21) Appl. No.: 12/332,330

(22) Filed: Dec. 10, 2008

(51) Int. Cl. H02K 21/00; H02K 15/03

(52) U.S. Cl. 310/152; 29/598

(57) ABSTRACT

A composite rotor of a step motor and a method for producing the same are disclosed. The composite rotor comprises a positioning member having a positioning protrusion, a first magnetic conductive member, at least one magnet and a second magnetic conductive member. The first magnetic conductive member, the magnet and the second magnetic conductive member are successively mounted on the positioning member and limited by the positioning protrusion. One end of the first magnetic conductive member and one end of the second magnetic conductive member abut against two opposite ends of the magnet, respectively.

### BACKGROUND OF THE INVENTION

1. Field of the Invention

The present invention relates to a rotor for a motor, and more particularly to a composite rotor of a step motor and a method for producing the composite rotor of a step motor.

2. Description of the Prior Art

Due to the advantages of low cost, simple to control and high precision, step motors are widely applied on precision positioning systems.

Please referring to FIG. 1, a rotor 10 for a step motor consists of a positioning member 11, a first magnetic conductive member 12, a magnet 13 and a second magnetic conductive member 14. The positioning member 11 is inserted through the first magnetic conductive member 12, the magnet 13 and the second magnetic conductive member 14 in order.

Further analysis shows that the above rotor 10 has the following disadvantages:

1. When the positioning member 11 is inserted through the first magnetic conductive member 12, the magnet 13 and the second magnetic conductive member 14, since the positioning member 11 is not designed with any positioning portion, the first magnetic conductive member 12, the magnet 13 and the second magnetic conductive member 14 are likely to slide uncontrollably.

2. The outer diameter of the magnet 13 are riveted to the first magnetic conductive member 12 and the second magnetic conductive member 14, which causes an clearance between the first magnetic member 12 and the second magnetic conductive member 14 to affect the magnetic field distribution of the magnet 13, thus making the rotor 10 impossible to use the magnetic field of the magnet 13 to further improve output power.

The present invention has arisen to mitigate and/or obviate the afore-described disadvantages.

### SUMMARY OF THE INVENTION

The primary objective of the present invention is to provide a composite rotor of a step motor and a method for producing the composite rotor, which has the advantages of stable assembly, enhancing magnet magnetic field distribution and increasing torque of the motor.

In order to achieve the above objective, a composite rotor of a step motor in accordance with the present invention comprises a positioning member, a first magnetic conductive member, a first magnet, a second magnet, a third magnet and a second magnetic conductive member. The positioning member is formed with a positioning protrusion. The first magnetic conductive member is formed with a through hole for insertion of the positioning member, one end of the first magnetic conductive member is formed with limiting concave communicating with the through hole, and the other end of the first magnetic conductive member abuts against the positioning protrusion of the positioning member. The first magnet is formed with an insertion hole for insertion of the positioning member and accommodated in the limiting concave of the first magnetic conductive member. The second magnet is formed with an insertion hole for insertion of the positioning member, and one side of the second magnet abuts against both the one end of the first magnetic conductive member and one side of the first magnet. The third magnet is formed with an insertion hole for insertion of the positioning member. The second magnetic conductive member is formed with a through hole for insertion of the positioning member, one end of the second magnetic conductive member is formed with a limiting concave for accommodation of the third magnet, and the limiting concave in the second magnetic conductive member communicates with the through hole in the second magnetic conductive member. Both the one end of the second magnetic conductive member and one side of the third magnet abut against the other side of the second magnet.

In order to achieve the above objective, a method for producing a composite rotor of a step motor in accordance with the present invention comprises the steps of:

A. forming: integrally forming a positioning protrusion on a positioning member; and

B. assembling: inserting the positioning member into a first magnetic conductive member embedded with a first magnet in such a manner that the first magnetic conductive member abuts against the positioning protrusion of the positioning member, and then the positioning member will be inserted into a second magnet in such a manner that the second magnet abuts against the first magnet and the first magnetic conductive member, after that, a second magnetic conductive member embedded with a third magnet will be mounted on the positioning member in such a manner that the third magnet and the second magnetic conductive member both abut against the second magnet.

In the method for producing the composite rotor in accordance with the present invention, the first magnet, the second magnet and the third magnet can also be integrally formed as a magnet.

Based on a further analysis of the above mentioned, the present invention can provide the following functions:

1. The first magnetic conductive member, the second magnetic conductive member and the magnet are assembled on the positioning member and limited by the positioning protrusion, so that the first magnetic conductive member, the magnet and the second magnetic conductive member cannot slide uncontrollably, thus increasing the assembly speed and promoting the production efficiency.

2. The first magnetic conductive member and the second magnetic conductive member abut against the magnet, respectively, so that there is no clearance between the first magnetic conductive member and the second magnetic conductive member, thus avoiding enlarging the distribution of the magnetic field of the magnet, and consequently, the output power of the rotor will be increased due to the enhanced magnetic field of the magnet.

### BRIEF DESCRIPTION OF THE DRAWINGS

FIG. 1 is an assembly view of a conventional rotor of a step motor;

FIG. 2 is an exploded view of a composite rotor of a step motor in accordance with the present invention;

FIG. 3 is a plane view of a positioning member for the composite rotor of a step motor in accordance with the present invention;

FIG. 4A is an assembly view of the positioning member and a first magnetic conductive member and a first magnet in accordance with the present invention;

FIG. 4B is a cross-sectional view of FIG. 4A;

FIG. 5A is an assembly view of the positioning member and the first magnetic conductive member and the first magnet and a second magnet in accordance with the present invention;

FIG. 5B is a cross-sectional view of FIG. 5A;

FIG. 6A is an assembly view of the positioning member and the first magnetic conductive member and the first magnet, the second magnet, a third magnet and a second magnetic conductive member in accordance with the present invention;

FIG. 6B is a cross-sectional view of FIG. 6A; and

FIG. 7 is an assembly view of a composite rotor of a step motor, which adopts an integrally-formed magnet in accordance with the present invention; and

FIG. 8 is a block diagram of a method for producing a composite rotor of a step motor in accordance with the present invention.

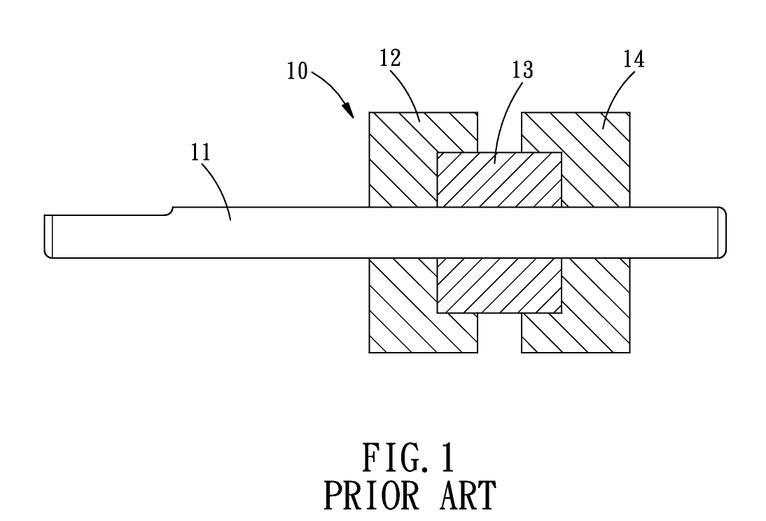

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

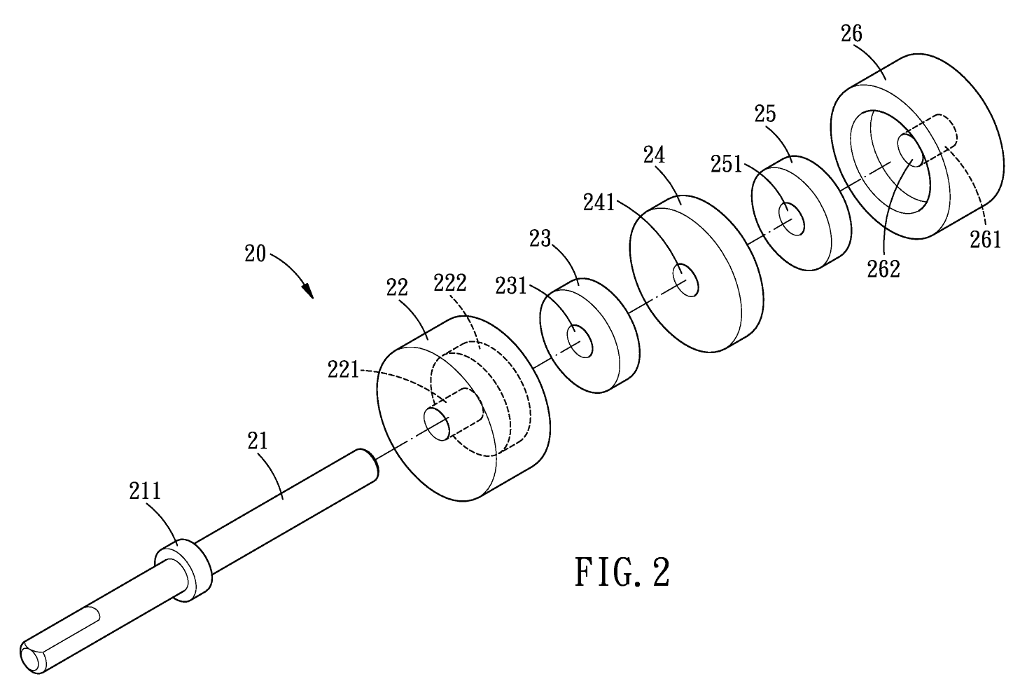

Referring to FIG. 2, a composite rotor 20 in accordance with a first embodiment of the present invention comprises a positioning member 21, a first magnetic conductive member 22, a first magnet 23, a second magnet 24, a third magnet 25 and a second magnetic conductive member 26.

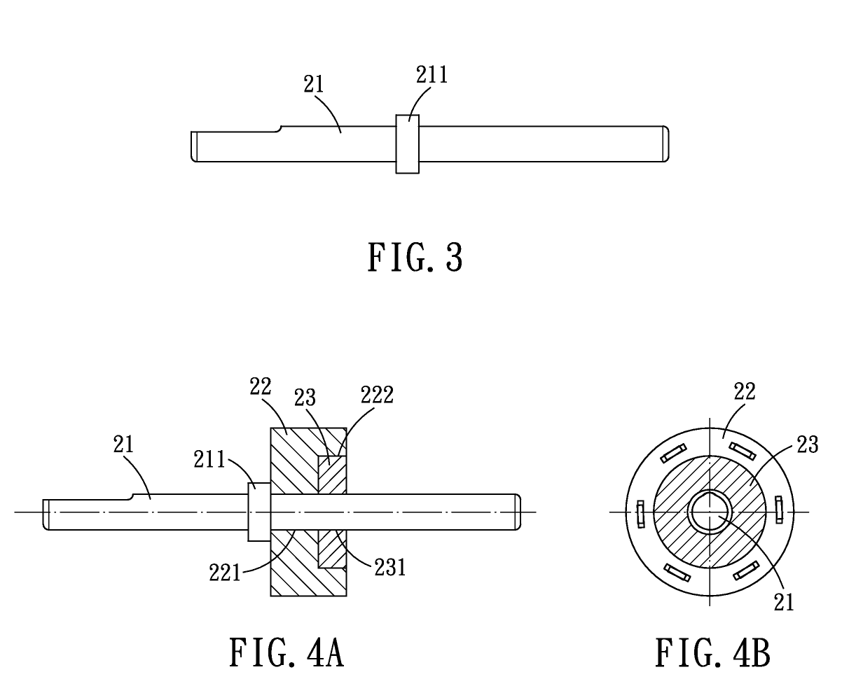

The positioning member 21, as shown in FIG. 3, is a cylindrical structure formed with an annular protrusion 211. The annular positioning protrusion 211 is bigger than the positioning member 21 in cross section.

The first magnetic conductive member 22 (as shown in FIGS. 4A and 4B) is a column-shaped structure formed of plural silicon steel sheets that are stacked one upon another by riveting. The first magnetic conductive member 22 is axially formed with a through hole 221 for insertion of the positioning member 21. One end of the first magnetic conductive member 22 is formed with a limiting concave 222, and the limiting concave 222 is formed at one end of the through hole 221 in such a manner that the limiting concave 222 and the through hole 221 communicate with each other. The other end of the first magnetic conductive member 22 abuts against the positioning protrusion 211 of the positioning member 21.

The first magnet 23 (as shown in FIGS. 4A and 4B) is disc-shaped in cross section. The first magnet 23 is axially formed with an insertion hole 231 for insertion of the positioning member 21 in such a manner that the first magnet 23 is accommodated in the limiting concave 222 of the first magnetic conductive member 22.

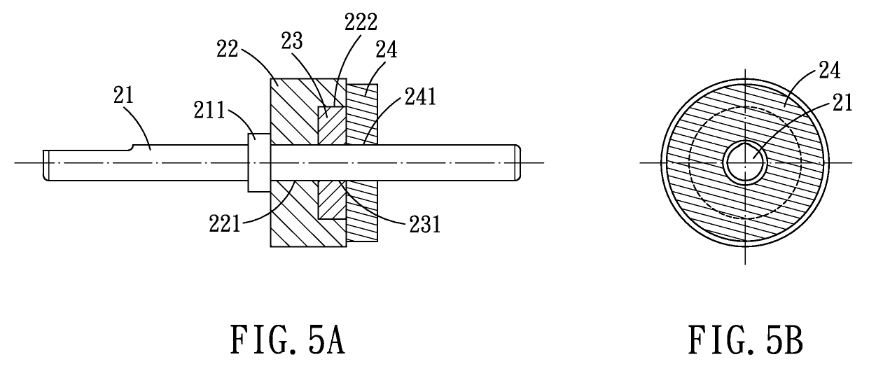

The second magnet 24 (as shown in FIGS. 5A and 5B) is disc-shaped in cross section and bigger in cross section than the first magnet 23. The second magnet 24 is axially formed with an insertion hole 241 for insertion of the positioning member 21 in such a manner that one side of the second magnet 24 abuts against the one end of the first magnetic conductive member 22 and one side of the first magnet 23. The abutting sides of the second magnet 24 and the first magnet 23 have the same magnetic polarity.

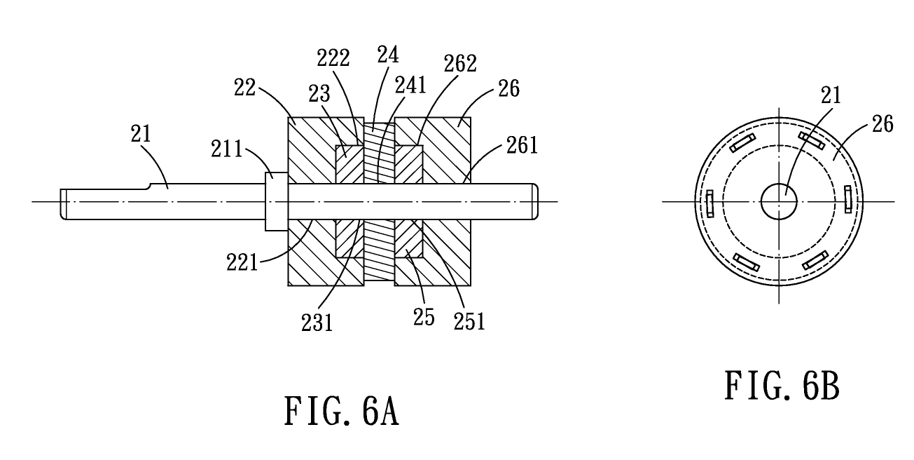

The third magnet 25 (as shown in FIGS. 6A and 6B) is disc-shaped in cross section and smaller in cross section than the second magnet 24 and identical in cross section to the first magnet 23. The third magnet 25 is axially formed with an insertion hole 251 for insertion of the positioning member 21. The abutting sides of the third magnet 25 and the second magnet 24 have the same magnetic polarity s.

The second magnetic conductive member 26 (as shown in FIGS. 6A and 6B) is a column-shaped structure formed of plural silicon steel sheets that are stacked one upon another by riveting. The second magnetic conductive member 26 is axially formed with a through hole 261 for insertion of the positioning member 21. One end of the second magnetic conductive member 26 is axially formed with a limiting concave 262 for accommodation of the third magnet 25. The limiting concave 262 is formed at one end of the through hole 261 in such a manner that the limiting concave 262 and the through hole 261 communicate with each other. Both the one end of the second magnetic conductive member 26 and one side of the third magnet 25 abut against the other side of the second magnet 24. By such an arrangement, the first magnetic conductive member 22 and the second magnetic conductive member 26 clamp the opposite sides of the second magnet 24 to limit the second magnet 24 on the positioning member 21.

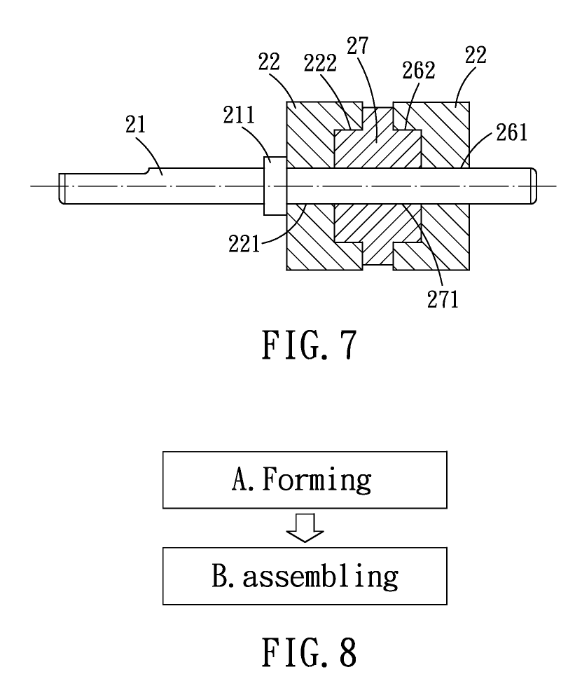

The first magnet 23, the second magnet 24 and the third magnet 25 can be integrally formed as an integral magnet 27. The two opposite ends of the magnet 27 (as shown in FIG. 7) are identical in cross section, but the middle portion of the magnet 27 is bigger in cross section than both ends of the magnet 27. The magnet 27 is axially formed with an insertion hole 271 for insertion of the positioning member 21. The magnet 27 is assembled to the positioning member 21, the first magnetic conductive member 22 and the second magnetic conductive member 26 respectively as follows.

The positioning member 21 is inserted into the first magnetic conductive member 22 through the through hole 221 in such a manner that one end of the first magnetic conductive member 22 abuts against the positioning protrusion 211 of the positioning member 21, and the positioning member 21 is then successively inserted through the magnet 27 through the insertion hole 271 and the second magnetic conductive member 26 through the through hole 261 in such a manner that the two ends of the magnet 27 are embedded into the limiting concave 222 of the first magnetic conductive member 22 and the limiting concave 262 of the second magnetic conductive member 26, respectively, and the first magnetic conductive member 22 and the second magnetic conductive member 26 clamp the middle portion of the magnet 27 to limit the magnet 27 on the positioning member 21.

Referring to FIG. 8, a method for producing a composite rotor in accordance with a first embodiment of the present invention comprises the steps of:

A. Forming: integrally forming a positioning protrusion 211 on a positioning member 21 (as shown in FIG. 3); and

B. Assembling: inserting the positioning member 21 into a first magnetic conductive member 22 embedded with a first magnet 23 (as shown in FIGS. 4-6) in such a manner that the first magnetic conductive member 22 abuts against the positioning protrusion, and then the positioning member 21 will be inserted into the second magnet 24 in such a manner that the second magnet 24 abuts against the first magnet 23 and the first magnetic conductive member 22, after that, a second magnetic conductive member 26 embedded with a third magnet 25 will be mounted on the positioning member 21 in such a manner that the third magnet 25 and the second magnetic conductive member 26 both abut against the second magnet 24.

Referring to FIG. 8, a method for producing a composite rotor in accordance with a second embodiment of the present invention comprises the steps of:

A. Forming: integrally forming a positioning protrusion 211 on a positioning member 21 (as shown in FIG. 3); and

B. Assembling: inserting the positioning member 21 into the first magnetic conductive member 22 in such a manner that the first magnetic conductive member 22 abuts against the positioning protrusion 211, as shown in FIG. 7, next, the positioning member 21 will be inserted into an integrally formed magnet 27 and a second magnetic conductive member 26 in such a manner that two opposite ends of the magnet 27 are respectively embedded into the first magnetic conductive member 22 and the second magnetic conductive member 26, and the middle portion of the magnet 27 abuts against the first magnetic conductive member 22 and the second magnetic conductive member 26.

If the composite rotor 20 in accordance with the present invention is applied to a step motor, under the condition that there is no change in the volume of the step motor, the magnetic energy product will enhance with the increase of the volume of the magnet of the composite rotor 20, and consequently the magnetic field of the magnetic circuit in the step motor will be enhanced, at this moment, the torque will be increased at least by 15%. As compared to the conventional step motor, the improvement of the step motor equipped with the composite rotor 20 in accordance with the present invention is shown in the following table:

| Step motor type | (BH)maxMGOe | Torque(N.m) |
|---|---|---|
| Conventional | 36 | 14.3 |
| The present invention | 42 | 16.5 |

While we have shown and described various embodiments in accordance with the present invention, it is clear to those skilled in the art that further embodiments may be made without departing from the scope of the present invention.

What is claimed is:

1. A composite rotor of a step motor comprising:
a positioning member being provided with a positioning protrusion;
a first magnetic conductive member being axially formed with a through hole for insertion of the positioning member, one end of the first magnetic conductive member being formed with a limiting concave communicating with the through hole, and the other end of the first magnetic conductive member abutting against the positioning protrusion of the positioning member;
a second magnetic conductive member being axially formed with a through hole for insertion of the positioning member, one end of the second magnetic conductive member being axially formed with a limiting concave for accommodation of the magnet, the limiting concave in the second magnetic conductive member communicating with the through hole in the second magnetic conductive member, the second magnetic conductive abutting against the other side of the middle portion of the magnet; and
a magnet being disposed between the first magnetic conductive member and the second magnetic conductive member.

2. The composite rotor of a step motor as claimed in claim 1, wherein the magnet has two opposite ends that are identical in cross section, a middle portion of the magnet is greater in cross section than both the two ends thereof, the magnet is axially formed with an insertion hole for insertion of the positioning member, one of the two ends of the magnet is embedded into the limiting concave of the first magnetic conductive member, and one side of the middle portion of the magnet abuts against the first magnetic conductive member;

3. The composite rotor of a step motor as claimed in claim 1, wherein the first magnetic conductive member is a structure formed of plural silicon steel sheets that are stacked one upon another by riveting, and the second magnetic conductive member is also a structure formed of plural silicon steel sheets that are stacked one upon another by riveting.

4. The composite rotor of a step motor as claimed in claim 1, wherein the magnet is divided into a first magnet, a second magnet and a third magnet, the first magnet is axially formed with an insertion hole for insertion of the positioning member in such a manner that the first magnet is accommodated in the limiting concave of the first magnetic conductive member, the second magnet is greater in cross section than the first magnet, the second magnet is axially formed with an insertion hole for insertion of the positioning member in such a manner that one side of the second magnet abuts against both one end of the first magnetic conductive member and one side of the first magnet, the third magnet is smaller in cross section than the second magnet, the third magnet is axially formed with an insertion hole for insertion of the positioning member.

5. The composite rotor of a step motor as claimed in claim 4, wherein the abutting sides of the first magnet and the second magnet have the same magnetic polarity, and the abutting sides of the second magnet and the third magnet also have the same magnetic polarity.

6. A method for producing a composite rotor of a step motor comprising the steps of:
forming: integrally forming a positioning protrusion on a positioning member; and
assembling: inserting the positioning member into a first magnetic conductive member embedded with a first magnet in such a manner that the first magnetic conductive member abuts against the positioning protrusion of the positioning member, and then the positioning member will be inserted into a second magnet in such a manner that the second magnet abuts against the first magnet and the first magnetic conductive member, after that, a second magnetic conductive member embedded with a third magnet will be mounted on the positioning member in such a manner that the third magnet and the second magnetic conductive member both abut against the second magnet.

7. A method for producing a composite rotor of a step motor comprising the steps of:
forming: integrally forming a positioning protrusion on a positioning member; and
assembling: inserting the positioning member into a first magnetic conductive member in such a manner that the first magnetic conductive member abuts against the positioning protrusion, next, the positioning member will be inserted into an integrally-formed magnet and a second magnetic conductive member in such a manner that two opposite ends of the magnet are respectively embedded into the first magnetic conductive member and the second magnetic conductive member, and a middle portion of the magnet abuts against the first magnetic conductive member and the second magnetic conductive member, respectively.
